(19) United States
(12) Patent Application Publication
(10) Pub. No.: US 2010/0202580 A1
(43) Pub. Date: Aug. 12, 2010

(54) METHOD AND APPARATUS FOR NEUTRON GENERATION USING LIQUID TARGETS

(75) Inventors: Jaeyoung Park, La Jolla, CA (US); Glen A. Wurden, Los Alamos, NM (US); Richard A. Nebel, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: LOS ALAMOS NATIONAL SECURITY, LLC, Los Alamos, NM (US)

(21) Appl. No.: 12/695,677

(22) Filed: Jan. 28, 2010

Related U.S. Application Data
(60) Provisional application No. 61/206,313, filed on Jan. 28, 2009.

(51) Int. Cl. G21B 1/17

(52) U.S. Cl. 376/108

(57) ABSTRACT

An apparatus and method for a beam target fusion neutron generator comprising a closed cycle flow generator having a continuous liquid phase flowing stream liquid target containing hydrogen isotopes where said stream has a continuously refreshed exposed surface and where said liquid target is high vacuum compatible at cryogenic temperatures; and an ion beam generator adapted to produce an ion beam and focused to direct said beam to bombard said flowing stream liquid target. The flowing stream liquid target can be a thin film curtain and said closed cycle flow generator can be a cryogenic liquid handling system having a heat exchanger adapted to maintain said liquid target at cryogenic temperatures and having a collection reservoir position to capture use target material for recycling.

### BACKGROUND OF INVENTION

1. Field of Invention

This invention relates generally to fusion neutron generation and, more particularly, to types of targets utilized for neutron generation.

2. Background Art

Neutrons may be produced using a number of techniques including radioactive isotopic sources, beam-target neutron generators and nuclear fission reactors. For example, isotopic neutron sources such as ²⁵²Cf can be utilized to produce continuous fluxes of neutrons in a small package. However, isotopic neutron sources require the use of radioactive materials. This limits the maximum neutron flux of the isotopic neutron source to a low level, typically below 1×10⁸ neutrons per second (n/s) due to the radiation safety. In comparison, beam-target neutron generators utilize nuclear reactions involving high energy ion beam, typically between 100-300 kilovolts (kV), impinging onto the proper target. The most commonly utilized reaction is the deuterium (²H)-tritium (³H) reaction and deuterium (²H)-deuterium (²H) reaction. Creating deuterium ions and accelerating these ions onto a tritium or deuterium target produces neutrons. Deuterium atoms in the beam fuse with deuterium and tritium atoms in the target to produce neutrons.

d+t→n+⁴He En=14.1 MeV

d+d→n+³He En=2.5 MeV

Typically, the neutron yield from the D-T reaction is ˜400 times higher than the neutron yield from the D-D reaction. By controlling the beam energy and intensity, it is possible to control the neutron flux from zero to very high levels, often higher than 10¹² n/s, making it safe to store and transport when not in use. Beam-target neutron generators have evolved over time from large and costly systems to compact and economical system. It can fit into a suit case and be hand portable with the price less than $50k. Though the other neutron generators such as nuclear fission reactor and high energy particle accelerators are occasionally used for special applications such as boron-neutron-capture-therapy (BNCT) for cancer treatment, most practical applications involving neutrons utilize the beam-target neutron generators.

Most common beam-target neutron generators are sealed tube neutron generators using an ion source, ion accelerator, and the fusion target, all of which are enclosed in within a vacuum tight enclosure. The ion source involves various types of plasma generators such as Penning ion source and rf plasmas. Once extracted from the ion source region, the deuterium ions are accelerated to high energies, between 100 kV and 300 kV. The accelerated ions strike the fusion target and produce neutrons. Typical targets consist of titanium, scandium, or zirconium or other like material that form stable chemical compounds called metal hydrides when combined with hydrogen or its isotopes. These metal hydrides are made up of two hydrogen (deuterium or tritium) atoms per metal atom and allow the target to have high densities of hydrogen. This is important for maximizing the neutron yield. They may be operated either as continuous or pulsed neutron sources. The neutrons produced are mono-energetic (2.5 MeV or 14 MeV). Typically, neutrons produced from the d-t reaction are emitted isotropically from the target, while the neutron emission from the d-d reaction is slightly peaked in the forward (along the axis of the ion beam) direction.

There are a number of applications involving neutrons. Neutrons can be used to analyze the elemental composition of material. When the neutron is captured by certain nuclei, the excited nuclei emit gamma rays at specific energies. By measuring resulting gamma ray energy spectrum, it is then possible to deduce the elemental composition under neutron exposure. The neutron based elemental analysis is particularly useful to detect C, N, O, Mg, Al, Si, S, and Ca and has been utilized for detection of explosives and illicit materials such as narcotics. In addition, neutrons have very different scattering properties compared to photons (x-rays and gamma rays), as it tends to scatter more frequently with lighter elements such as hydrogen and helium, while it passes through heavier elements easily. By analyzing the neutron transmission and absorption properties, three dimensional material structure can be investigated non-destructively. Also, the neutron can cause nuclear reactions in certain radio materials such as highly enriched uranium, which is very difficult to detect by other means. This allows the neutron based interrogation method for radioactive materials.

Commercial neutron generators using the beam-target fusion concept provide neutron fluxes from 1×10⁷ n/s up to more than 1×10¹⁰ n/s. Neutron generators are used for a wide variety of applications in science and engineering, particularly through the processes of nuclear activation and scattering. Applications include: 1. Nuclear oil well logging and mineral resources exploration; 2. Moisture content gauges; 3. Quality control of neutron absorber materials involved in the nuclear fuel cycle; 4. Analysis of nuclear materials; 5. Neutron radiography; and 6. Non-destructive detection of explosives, drug contraband and radioactive materials.

One of the most critical aspects of the beam-target neutron generator is the target integrity under the beam exposure. Due to the energetic ion bombardment to the solid targets, these neutron generators suffer damage to the target such as target erosion and depletion of hydrogen isotopes in the active layer, especially for the ones operating at high neutron fluxes. This limits the target lifetime to less than a few hundred hours and greatly increases the operating cost of the neutron generators because frequent target replacement is needed. In addition to target lifetime concerns, neutron source geometry can have a significant impact on various applications. For instance, for neutron radiography, image quality is dependent on having a very small point source providing an isotropic flux of neutrons. Typically in a beam-target system, the ion beam is defocused to mitigate localized erosion of the target. In addition, the target must be relatively thick and water cooled to avoid melting, resulting in anisotropicies from scattering in the target and cooling water.

Deterioration of the target and its effect on the life of the generator is a problem that should be addressed for high flux neutron applications. In addition, the target cooling greatly limits the scope of neutron imaging applications.

### BRIEF SUMMARY OF INVENTION

The invention is a neutron generator, which is designed to overcome many of the limitations of traditional beam-target neutron generators by utilizing a liquid target neutron source, as depicted in FIG. 1. The liquid target can generally be referred to as a “self-healing” (i.e., is constantly being replenished) where there is no target “lifetime” issue in the conventional sense. Liquid that is lost to evaporation can be captured in cold traps and recycled. Loses to degradation mechanisms, such as dissociation and polymerization, would occur over time, but can be rectified through liquid addition and/or replacement. As a result, there is no inherent target lifetime for the liquid target neutron generator when used with continuous refreshment of the target surface exposed to the energetic beam. This will reduce the operating cost of the neutron generators, thus making them more economical for a wider array of applications. This benefit will be biggest for the high flux applications (in excess of 1×10⁹ n/s) such as nuclear assay applications for cargo containers and large vehicles, and radiography of weapons components. Furthermore, since this process can be easily scaled, the enhanced target lifetime can increase the maximum neutron fluxes beyond current 1×10¹⁰ n/s level to 10¹² n/s or even higher. At such high neutron fluxes, there will be additional applications for intense neutron generators such as neutron tomography for materials study and medical isotope production.

Another critical advantage of using a liquid target is that beams can be focused arbitrarily small since the liquid surface is continuously replenished and the heat is carried away to be removed in a refrigeration unit. This could satisfy the need for intense point neutron sources for radiography. The smaller the source, the sharper the radiograph and the higher the resolution. Potentially liquid targets could allow a point neutron source whose spatial extension is on the order of 1 μm to 10 μm. Since the liquid target can be maintained relatively thin with no need for water cooling, there would be minimal scattering of the neutrons as they leave the source.

Another advantage is that one can use MeV ion beams to produce directed neutron sources for low dose nuclear materials interrogation. A neutron source currently under development uses a 3 MeV ion beam impacting a gas target. The gas target must be separated from the high vacuum beam acceleration region by a thin foil. This foil must be thin enough to allow the beam to pass into the gas without losing significant energy, but thick enough to hold ˜1 atmosphere of differential pressure. Beam erosion of the foil limits the lifetime. However, due to the present invention's incorporation of a vacuum-compatible liquid target, the need to use a foil is eliminated.

Using up to a 5 MeV deuterium ion beam, directed onto a deuterated target, it is possible to produce a directed beam of up to 7.5 MeV neutrons. This has particular appeal in the detection on nuclear materials where there is a need to direct neutrons onto locations of interest in shipping containers. By staying below ˜8 MeV, one can eliminate interfering threshold reactions and improve detectability of fissile material, yet still be sufficiently intense and penetrating.

It is noted that the ratio of hydrogen isotope ions to total electrons in the target is higher in liquid propane, than the current metal hydride targets such as titanium hydride and palladium hydride. This suggests a higher fusion yield for the liquid targets compared to the currently available solid targets. The key issue is the availability of hydrogenated liquid phases and their compatibility with a high vacuum environment. Since the ion energy of the fusion neutron generators is on the order of from about 100 keV to about 1 MeV, the ion beam loses much of its energy and flux if exposed to residual gas. Typically, an operating pressure of mTorr or less in the beam acceleration and the transport region to the target is necessary to operate the neutron generator efficiently. In addition, the liquid target materials must contain a high fraction of hydrogen isotopes to be used as an efficient fusion target.

One embodiment to achieve these conditions is to use cryogenically cooled hydrocarbons (such as liquid propane, either deuteriated or tritiated). At around 110K, propane remains in liquid phase with very low vapor pressure on the order of 10 mTorr, thus compatible with the high vacuum environment. Other hydrocarbons such as methane and ethane or ammonia may be used to create the cryogenic liquid phase compatible with high vacuum environment. The use of moderate cryogenic temperature can keep the cost of target system low by using liquid nitrogen (77K) as a coolant rather than liquid helium. Still, the cost of the cryogenic system would be low compared to the cost of replacing solid target materials in present commercial beam-target neutron generators. It is noted that liquid hydrogen isotopes would work well, if one can cool them at very low temperatures, albeit at an increased cost.

Another option as the liquid target would be molten salts containing hydrogen isotopes such as lithium deuteride that can have a liquid phase at elevated temperature with relatively low vapor pressure. Once target materials, which possess liquid properties that are compatible with the high vacuum environment are chosen, various methods can be utilized to constantly refresh the liquid surface exposed to the high energy ion beam to mitigate target damage. Liquid targets can be in the form of a flowing liquid stream with and without adjacent solid target. It is noted that the high fusion target density of the liquid targets and the relatively low beam energy (100 keV to 1 MeV) allows the use of relatively thin liquid targets on the order of 1 mm or less. This allows various flow systems such as nozzles, jet spray, slits and orifice to produce the flowing liquid stream. In addition, flowing droplets and thin films can also be used as liquid targets.

The liquid target stream can be recycled by collecting the target materials once they pass the beam trajectory and pumping them back to the flow systems. Constant cooling of the target system including the flow generator, the target collector, and the pump system can be used to ensure the appropriate heat removal from the ion beams and ambient heat transfer.

Liquid targets have been used or proposed for other applications. For instance, the use of liquid mercury targets has been chosen as the basis for the Spallation Neutron Source in Tennessee. A spallation neutron source differs from the fusion neutron source as the neutrons are generated by the spallation process (knocked out by fast proton particles). It typically operates with much higher beam energy (over 20 MeV compared to 0.1-1 MeV range for the fusion neutron source) and a heavy nucleus target such as mercury (compared to targets containing hydrogen isotopes). Another example of neutron generators using liquid target is the proposed IFMIF (International Fusion Materials Irradiation Facility). In that proposed system, the liquid lithium target is to be used for D-Li fusion reaction for neutron generation. However, this differs from the present invention such that the liquid lithium target does not contain any hydrogen isotopes and cannot be used in simple fusion channels such as D-D and D-T fusion reactions.

Therefore, based on the above, one embodiment of the invention can be a beam target fusion neutron generator comprising a closed cycle flow generator having a continuous liquid phase flowing stream liquid target containing hydrogen isotopes where said stream has a continuously refreshed exposed surface and where said liquid target is high vacuum compatible at cryogenic temperatures; and an ion beam generator adapted to produce an ion beam and focused to direct said beam to bombard said flowing stream liquid target. The flowing stream liquid target can be a thin film curtain and said closed cycle flow generator can be a cryogenic liquid handling system having a heat exchanger adapted to maintain said liquid target at cryogenic temperatures and having a collection reservoir position to capture use target material for recycling.

These and other advantageous features of the present invention will be in part apparent and in part pointed out herein below.

### BRIEF DESCRIPTION OF THE DRAWINGS

For a better understanding of the present invention, reference may be made to the accompanying drawing in which:

FIG. 1 is an illustration of a liquid target ion beam neutron source, also showing both liquid recapture and a heat exchanger.

While the invention is susceptible to various modifications and alternative forms, specific embodiments thereof are shown by way of example in the drawing and will herein be described in detail. It should be understood, however, that the drawing and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF INVENTION

This invention describes the methods to use liquid targets containing hydrogen isotopes to produce fusion neutrons. The use of hydrocarbons such as propane or ammonia at cryogenic temperatures can simultaneously utilize the liquid phase and high vacuum compatibility. Since the target surface can be regenerated continuously in liquid phase by flowing the liquid stream (or droplets, jets, thin films), the beam damage to the target can be mitigated and a much increased target lifetime can be obtained. The high vacuum compatibility of such liquid targets maintains high fusion neutron generation efficiency, while a high atomic fraction of hydrogen isotopes, in these targets may even improve the fusion efficiency. Similar benefits can also be obtained if one uses the molten salts such as Lithium deuteride at elevated temperature while keeping the vapor pressure low.

The use of liquid targets containing hydrogen isotopes for fusion neutron generation is the critical aspect of the present invention. The choice of liquid targets can include materials such as propane, methane, ethane, hydrocarbons, and ammonia. These materials can be employed at cryogenic temperatures. Also, the use of molten salts such as lithium deuteride at elevated temperatures as a fusion neutron liquid target is another option.

This invention describes the method which greatly lengthens the target lifetime of beam-target fusion neutron generators. In addition, the use of high vacuum compatible liquid targets maintains the fusion efficiency by limiting the beam loss channels with high vacuum operation. There is no inherent target lifetime for the liquid target when used with continuous refreshment of the target surface exposed to the energetic beam. This will greatly reduce the operating cost of the neutron generators, thus making them more economical. This benefit will be biggest for the high flux applications (in excess of 1×10⁹ n/s) such as nuclear assay applications for cargo containers and large vehicles. Furthermore, since this process can be easily scalable, the enhanced target lifetime can increase the maximum neutron fluxes beyond current 1×10¹⁰ n/s level to 10¹² n/s or even higher. At such high neutron fluxes, there will be additional applications for intense neutron generators such as neutron tomography for materials study and medical isotope production. With sufficient neutron moderation system, the high flux neutron generator based on the liquid target may be used as a neutron source in BNCT (boron neutron capture therapy) instead of fission reactors. It is noted that the ratio of hydrogen isotope ions to total electrons in the target is higher than the current metal hydride targets such as titanium hydride and palladium hydride. This suggests the higher fusion yield of the proposed liquid targets compared to the currently available solid targets.

Intense neutron source for active nuclear interrogation of special nuclear materials. Neutron source for nuclear interrogation of high explosives such as landmine and unexploded ordinance. Neutron tomography for materials structure and integrity study. Nuclear isotope generation for medical applications. Neutron source for BNCT (boron neutron capture therapy) cancer treatment.

This invention describes the methods to use liquid targets containing hydrogen isotopes to produce fusion neutrons, mitigating the beam damage to the target. The key issue is the availability of liquid phase of target materials and its compatibility with the high vacuum environment. Since the ion energy of the fusion neutron generators is the order of 100 keV 1 MeV, the ion beam (either positive deuteriurn atomic ions or positive tritium atomic ions) quickly loses the energy and the flux if exposed to residual gases. Typically, the operating pressure of less than 1 mTorr in the beam acceleration and the transport region to the target is necessary to operate the neutron generator efficiently. In addition, the liquid target materials must contain a high fraction of hydrogen isotopes to be used as an efficient fusion target.

One embodiment to achieve these conditions is to use cryogenically cooled hydrocarbons (such as liquid propane, either deuteriated or tritiated). At around about 110K, the propane remains in the liquid phase with a very low vapor pressure on the order of 1 Pascal. This makes the cryogenic propane at those temperatures compatible with the high vacuum environment. Other hydrocarbons such as methane and ethane or ammonia may be used to create the similar cryogenic liquid phase conditions compatible with high vacuum environment. The use of moderate cryogenic temperatures (above about 77K) can keep the cost of target system low by using liquid nitrogen as coolants rather than liquid helium. Still, the cost of cryogenic system would be low compared to the cost of replacing solid targets in present commercial beam-target neutron generators.

It is noted that a liquid target made of pure hydrogen isotopes would work well, if one can cool it at very low temperatures at an increased cost. Another embodiment would a molten salt containing hydrogen isotopes such as lithium deuteride that can have liquid phase at elevated temperatures with relatively low vapor pressure. Once the liquid target materials compatible with the high vacuum environment are selected, various methods can be utilized to constantly refresh the liquid surface exposed to the high energy ion beam to mitigate the target damage.

Liquid targets can be in the form of flowing liquid stream with and without adjacent solid targets. It is noted that the high fusion target density of the liquid targets and the relatively low beam energy (100 keV 1 MeV) allows the use of relatively thin liquid targets on the order of 1 mm thickness or less. This allows various flow system such as the nozzles, the jet spray, the slits and the orifice to produce flowing liquid stream. In addition, flowing droplets and thin films can also be used as liquid targets.

The spent and bombarded liquid target stream can be captured and recycled by collecting the target materials once they pass the beam trajectory and by pumping it back to the flow systems. In a cryogenic system, cooling of the target system including the flow generator, the target collector, and the pump system can be used to ensure the appropriate heat removal from the energetic ion beams and the ambient heat transfer. In a heated system, both heat removal and/or additional heating can be used to maintain the optimal phase space operation (temperature-pressure parameters) depending on the operating parameters. There is no inherent target lifetime for the liquid target when used with continuous refreshment of the target surface exposed to the energetic beam. This can greatly reduce the operating cost of the neutron generator, thus making them more economical. This benefit can be biggest for the high flux applications (in excess of 1×10⁹ n/s) such as nuclear assay applications for cargo containers and large vehicles as well as high explosives such as landmine.

Furthermore, since this process can be easily scalable, the enhanced target lifetime can increase the maximum neutron fluxes beyond current 1×10¹⁰ neutrons/s level to 10¹² neutrons/s or even higher. At such high neutron fluxes, there will be additional applications for intense neutron generators such as neutron tomography for materials study and medical isotope production. It is noted that the ratio of hydrogen isotope ions to total electrons in the target is higher than the current metal hydride targets such as titanium hydride and palladium hydride thus the targets can be considered hydrogen isotope rich targets. This suggests the higher fusion yield of the liquid targets compared to the currently available solid targets.

One embodiment of the present invention comprising a closed cycle flow generator having a continuous liquid phase flowing stream liquid target containing hydrogen isotopes where said stream has a continuously refreshed exposed surface and where said liquid target is high vacuum compatible and at cryogenic liquid phase temperatures; and an ion beam generator adapted to produce an ion beam and focused to direct said beam to bombard said flowing stream liquid target, teaches a novel apparatus and method for neutron generator.

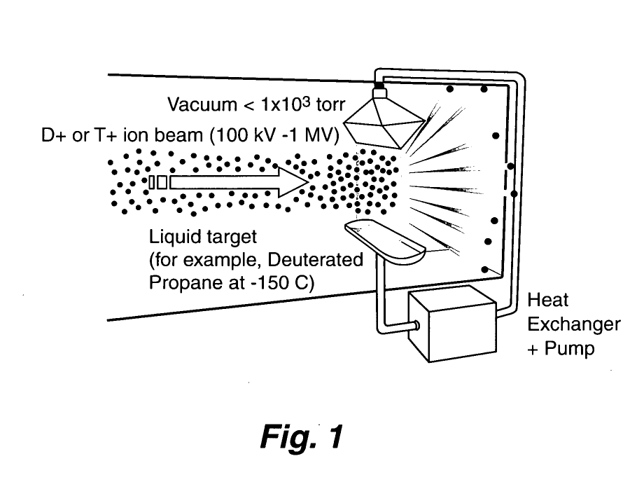

The details of the invention and various embodiments can be better understood by referring to FIG. 1, wherein neutron generator 100 is shown. The neutron generator 100 includes a vacuum container 101 for containing the ion beam source and the closed cycle flow generator within a vacuum. The ions beam source emits an ion beam 102 directed toward the closed cycle flow generator 104. The closed cycle flow generator generates a continuous liquid phase flowing stream liquid target 106. The liquid target 106 is bombarded by the ion beam 102. The liquid target is generated by the liquid pump 108 and nozzle 110. FIG. 1 further illustrates a liquid phase flowing stream curtain of liquid that creates a liquid target for the generation of neutron emissions as reflected by 120. The nozzle 110 can be configured to create a thin film liquid target as shown. As the liquid target continuously flows, the spent and bombarded liquid can be captured in a collection reservoir 112 which can channel the spent liquid through an exchanged line, thereby channeling the liquid to a heat exchanger 116 in order to maintain the liquid at cryogenic temperatures. Once the liquid has passed through the heat exchanger 116, it can be channeled back to the liquid pump 108 by way of the replenished line 118. Within this closed system, there can also be a hydrogen isotope replenishment mechanism for replenishing the cryogenic liquid with hydrogen isotopes. This continuous liquid flow system continuously provides a new target for bombardment by the ion beam.

The various neutron generator examples shown above illustrate a novel liquid target neutron generator. A user of the present invention may choose any of the above liquid target embodiments, or an equivalent thereof, depending upon the desired application. In this regard, it is recognized that various forms of the subject invention could be utilized without departing from the spirit and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the sprit and scope of the present invention.

Other aspects, objects and advantages of the present invention can be obtained from a study of the drawing, the disclosure and the appended claims.

What is claimed is:

1. A beam target fusion neutron generator comprising:
a closed cycle flow generator having a liquid target stream containing hydrogen isotopes where said liquid target stream has a regularly refreshed exposed surface and where said liquid target stream has a vapor pressure less than about 1 Torr; and,
an ion beam generator adapted to produce an ion beam, said ion beam generator focused to direct said ion beam onto said liquid target stream whereby neutrons are generated.

2. The neutron generator of claim 1 wherein said flow generator and said ion beam are contained within a vacuum chamber.

3. The neutron generator of claim 1 wherein said liquid target stream includes non-continuous intermittent drops.

4. The neutron generator of claim 1 wherein said liquid target stream is a thin film curtain.

5. The neutron generator of claim 1 wherein said closed cycle flow generator further includes a cryogenic liquid handling system having a heat exchanger adapted to maintain said liquid target stream at cryogenic temperatures and having a collection reservoir for capture of used liquid target stream and subsequent recycle.

6. The neutron generator of claim 4 wherein said thin film curtain has a thickness of from about 10 micrometers to about 2 centimeters.

7. The neutron generator of claim 1 wherein said thin film curtain has a thickness of from about 10 micrometers to about 1 millimeter.

8. The neutron generator of claim 1 wherein said liquid target stream is a continuous stream of droplets.

9. The neutron generator of claim 1 wherein said liquid target stream comprises a component selected from the group consisting of propane, ethane, methane and ammonia.

10. The neutron generator of claim 1 wherein said liquid target stream comprises propane.

11. The neutron generator of claim 5 wherein said liquid target stream comprises propane.

12. The neutron generator of claim 1 wherein said liquid target stream comprises a molten salt.

13. The neutron generator of claim 12 wherein said molten salt comprises lithium deuteride.

14. The neutron generator of claim 11 wherein said cryogenic temperatures are in the range of from about 90K to about 200K.

15. The neutron generator of claim 1 wherein the ion beam generator is adapted to produce a D⁺ beam having a beam energy of from about 10 kV to about 500 kV.

16. The neutron generator of claim 15 wherein the liquid target stream is comprises propane to achieve a neutron output of greater than about 1×10⁹ neutron per second (n/s) steady state neutrons.

17. A neutron generator target comprising:
a vacuum chamber; and,
a closed cycle flow generator within said vacuum chamber, said closed cycle flow generator having a liquid target stream containing hydrogen isotopes where said liquid target stream has a regularly refreshed exposed surface and where said liquid target stream has a vapor pressure less than about 1 Torr.

18. The neutron generator target of claim 17 wherein said closed cycle flow generator further includes a cryogenic liquid handling system having a heat exchanger adapted to maintain said liquid target stream at cryogenic temperatures and having a collection reservoir for capture of used liquid target stream and subsequent recycle.

19. The neutron generator target of claim 18 wherein said cryogenic liquid handling system further includes a liquid pump and nozzle formed to generate a thin film curtain from said liquid target stream.

20. The neutron generator target of claim 19 wherein said thin film curtain has a thickness of from about 10 micrometers to about 2 centimeters.

21. The neutron generator target of claim 19 wherein said thin film curtain has a thickness of from about 10 micrometers to about 1 millimeter.

22. The neutron generator target of claim 18 wherein said cryogenic temperatures are in the range of from about 90K to about 200K.

23. The neutron generator target of claim 17 wherein said liquid target stream comprises a component selected from the group consisting of propane, ethane, methane and ammonia.

24. The neutron generator target of claim 17 wherein said liquid target stream comprises propane.

25. The neutron generator target of claim 17 wherein said liquid target stream comprises a molten salt.

26. The neutron generator target of claim 25 wherein said molten salt comprises lithium deuteride.

27. A method for generating neutrons comprising:
generating a liquid target stream containing hydrogen isotopes within a vacuum container at low pressures of less than about 1 Ton where said liquid target stream has a regularly refreshed exposed surface and where said liquid target stream has a vapor pressure less than about 1 Ton; and,
generating an ion beam focused so as to direct said ion beam onto said liquid target stream within said vacuum container whereby neutrons are generated.

28. The method of generating neutrons of claim 27 wherein said liquid target stream comprises a component selected from the group consisting of propane, ethane, methane and ammonia.

29. The method of generating neutrons of claim 27 further including:
maintaining said liquid target stream at cryogenic temperatures.

30. The method of generating neutrons of claim 29 wherein said cryogenic temperatures are in the range of from about 90K to about 200K.

31. The method of generating neutrons of claim 27 wherein said liquid target stream comprises a molten salt.

32. The method of generating neutrons of claim 31 wherein said molten salt comprises lithium deuteride.

33. The method of generating neutrons of claim 27 wherein said liquid target stream is a thin film curtain.

34. The method of generating neutrons of claim 33 wherein said thin film curtain has a thickness of about 10 micrometers to about 2 centimeters.

35. The method of generating neutrons of claim 33 wherein said thin film curtain has a thickness of from about 10 micrometers to about 1 millimeter.

36. The method of generating neutrons of claim 27 further including capturing a used liquid target stream and subsequently recycling said captured used liquid target stream.

37. The method of generating neutrons of claim 36 further including replenishing the used liquid target stream during any recycling with hydrogen isotopes.
